(19) United States
(12) Patent Application Publication
(10) Pub. No.: US 2025/0368110 A1
(43) Pub. Date: Dec. 4, 2025

(54) PADDING ASSEMBLY FOR VEHICLE SEAT AND METHOD OF PRODUCING A PADDING ASSEMBLY

(71) Applicants: FAURECIA Sièges d'Automobile, NANTERRE (FR); Indorama Ventures Mobility Obernburg GmbH, Obernburg (DE)

(72) Inventors: Mathieu CLUET, ETAMPES (FR); Fabrice ETIENNE, BAVILLIERS (FR); Mathieu BOQUET, VERRIERES LE BUISSON (FR); Anthony MAIRE, MONTBELIARD (FR)

(21) Appl. No.: 19/220,883

(22) Filed: May 28, 2025

(30) Foreign Application Priority Data
May 29, 2024 (FR) 2405549

(51) Int. Cl. B60N 2/70

(52) U.S. Cl. CPC B60N 2/7017

(57) ABSTRACT

A padding assembly for a vehicle seat, comprising: a padding comprising an entanglement of fibers, the entanglement of fibers comprising fibers, the fibers being made of thermoplastic material, forming loops and welded to each other, the entanglement of fibers having a passage, a retaining element, the retaining element comprising a first portion, a second portion, and a connecting portion, the first portion comprising a hooking portion, the second portion engaging with the reverse face, the connecting portion extending in the passage, the retaining element being fixed to the entanglement of fibers by a melting of material.

### PRIORITY CLAIM

This application claims priority to French Patent Application No. FR2405549, filed May 29, 2024, which is expressly incorporated by reference herein.

### BACKGROUND

The present disclosure relates to a padding assembly for a vehicle seat and to a method of producing a padding assembly for a vehicle seat.

### SUMMARY

According to the present disclosure, a padding assembly comprises a retaining element, the retaining element comprising a first portion, a second portion, and a connecting portion, the first portion comprising a hooking portion intended to retain a cover which covers the support face, the second portion engaging with the reverse face to hold the retaining element in the entanglement of fibers, the connecting portion extending in the passage and connecting the first portion to the second portion, and the retaining element being fixed to the entanglement of fibers by a melting of material.

The padding can thus provide the flexibility necessary for user comfort and the retaining element can have high robustness.

In another feature in accordance with the disclosure, the retaining element is preferably fixed to the entanglement of fibers by fusion using ultrasonic vibrations.

Fusion using ultrasonic vibrations allows melting the elements only locally at the point where they are in contact, in order to secure them while avoiding deformation, particularly at the hooking portion.

In another feature in accordance with the disclosure, the retaining element is preferably a single piece.

The retaining element is thus simpler and more robust.

In another feature in accordance with the disclosure, the retaining element is made of solid material.

The robustness of the retaining element is thus increased. The retaining element does not need to offer as much flexibility as the padding, since it is not intended to come into contact with the user.

In another feature in accordance with the disclosure, the retaining element is preferably obtained by additive manufacturing.

The retaining element may thus have complex shapes.

In another feature in accordance with the disclosure, the second portion preferably has a stop surface which abuts against the reverse side of the entanglement of fibers, and the stop surface is fixed to the entanglement of fibers by melting the entanglement of fibers.

The positioning and retention of the retaining element relative to the entanglement of fibers are thus improved.

In an additional feature in accordance with the disclosure, the passage preferably has an oblong cross-section and the connecting portion of the retaining element has a complementary cross-section.

The connecting portion is thus prevented from rotating in the passage.

In an alternative feature according to the present disclosure, the first portion preferably has a retaining surface which abuts against the support face of the entanglement of fibers, and the second portion is crushed by melting and has a stop surface which abuts against the reverse face of the entanglement of fibers.

The positioning and retention of the retaining element relative to the entanglement of fibers are thus also improved.

In a complementary feature according to the present disclosure, the retaining element is preferably deformed by riveting.

In a complementary or alternative feature according to the disclosure, the second portion preferably has an annular (half-toroidal) bead shape.

This thus creates a reinforcement at the connection between the retaining element and the entanglement of fibers.

In an additional feature in accordance with the disclosure, the entanglement of fibers is preferably of increased density around the passage.

The strength of the entanglement of fibers is thus increased near its attachment to the retaining element.

In another additional feature in accordance with the disclosure, the entanglement of fibers is preferably made of a first material and the retaining element is made of a second material, the first material and the second material having similar physicochemical properties.

Thus, not only is the retaining element held in place relative to the entanglement of fibers by obstacles, but, in addition, the retaining element is welded to the entanglement of fibers.

In various embodiments of the padding assembly according to the disclosure, one more of the following arrangements may optionally be used:
the first material and the second material are each a thermoplastic polymer having a main-chain repeating unit comprising an ester or ether functional group;
the first material and the second material have the same chemical composition;
the first material and the second material comprise at least 90% poly(ethylene terephthalate),
the hooking portion is elastically deformable.

In another feature in accordance with the disclosure, the padding assembly further comprises a cover and a hooking stud connected to the cover, the cover covers the support face of the entanglement of fibers, and the hooking stud engages with the hooking portion to retain the cover on the entanglement of fibers.

The present disclosure further relates to a method of producing a padding assembly for a vehicle seat. The method comprises the following operations:
a) providing a padding comprising an entanglement of fibers and a retaining element, the entanglement of fibers comprising fibers made of thermoplastic material, forming loops and welded to each other, the entanglement of fibers having a support face and a reverse face, the support face being intended to face towards a user, the reverse face being opposite to the support face, the entanglement of fibers having a passage extending between the support face and the reverse face, the retaining element comprising a first portion, a second portion, and a connecting portion, the first portion comprising a hooking portion intended to retain a cover which covers the support face, the connecting portion connecting the first portion to the second portion,
b) inserting the connecting portion into the passage,
c) engaging the second portion with the reverse face and fixing the retaining element to the entanglement of fibers by a melting of material.

In various embodiments of the method according to the disclosure, one or more of the following arrangements may optionally be used:
during operation c), a sonotrode generating ultrasonic vibrations is used;
during operation b), the first portion is inserted into the passage, then the connecting portion is inserted into the passage until a stop surface of the second portion abuts against the reverse face of the entanglement of fibers;
during operation c), the second portion is held on a support, the sonotrode is applied against the support face of the entanglement of fibers, and the sonotrode is brought closer to the support;
during operation c), the support face of the entanglement of fibers is applied against a support, the second portion is held on the sonotrode, and the sonotrode is brought closer to the support;
during operation b), the second portion is inserted into the passage, then the connecting portion is inserted into the passage until a retaining surface of the first portion abuts against the support face of the entanglement of fibers;
during operation c), the first portion is applied against a support, the second portion is held on the sonotrode, the sonotrode melts the second portion by means of ultrasonic energy, then the sonotrode is brought closer to the support in order to crush the second portion against the reverse face of the entanglement of fibers;
the sonotrode has a head with a recess in the shape of a half-toroid;
operation a) comprises producing the retaining element by additive manufacturing.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 represents a seat comprising a padding assembly;

FIG. 2 represents padding according to a first operation in a method of producing a padding assembly according to a first exemplary embodiment;

FIG. 3 is a section view along line III-III in FIG. 2;

FIG. 4 illustrates a second operation in the method according to the first exemplary embodiment;

FIG. 5 illustrates a third operation in the method according to the first exemplary embodiment;

FIG. 6 illustrates the first operation in a method according to a second exemplary embodiment;

FIG. 7 illustrates the second operation in the method according to the second exemplary embodiment;

FIG. 8 illustrates the third operation in the method according to the second exemplary embodiment;

FIG. 9 is a partial perspective view from the arrow denoted IX in FIG. 6;

FIG. 10 is a partial perspective view from the arrow denoted X in FIG. 8;

FIG. 11 illustrates the first operation in a method according to a third exemplary embodiment;

FIG. 12 illustrates the second operation in the method according to the third exemplary embodiment;

FIG. 13 illustrates the third operation in the method according to the third exemplary embodiment;

FIG. 14 illustrates the first operation in a method according to a variant of the third exemplary embodiment; and

FIG. 15 illustrates the second operation in the method according to the variant of the third exemplary embodiment.

### DETAILED DESCRIPTION

For the most part, the drawings and the following description contain elements that are certain in nature. Therefore not only may they serve to provide a better understanding of this disclosure, but where appropriate may also contribute to its definition.

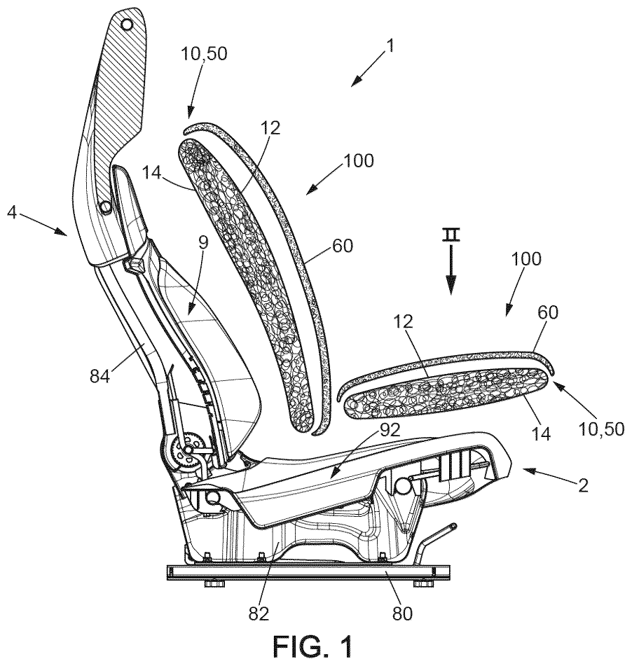

Thus, as illustrated in FIG. 1, the present disclosure relates to a seat 1 comprising a seating portion 2 and a backrest 4.

Seating portion 2 comprises a seating portion structure 82 connected to a vehicle floor by means of slides 80. Backrest 4 comprises a backrest structure 84 that is hinged relative to seat base structure 82. Seating portion 2 and the backrest each comprise a padding assembly 100. As illustrated in FIG. 1, seating portion 2 further comprises a seating portion interface 92 arranged between seating portion structure 82 and the corresponding padding assembly 100, and backrest portion 4 comprises a backrest interface 94 arranged between backrest structure 84 and the corresponding padding assembly 100.

Padding assembly 100 comprises padding 50 and a cover 60. Padding 50 comprises an entanglement of fibers 10. In the illustrated embodiments, padding 50 solely comprises entanglement of fibers 10. Alternatively, entanglement of fibers 10 could constitute only part of padding 50, for example the padding could also comprise a foam part. The thickness of padding 50 may be between 23 mm and 50 mm. Entanglement of fibers 10 has a support face 12 and a reverse face 14. Support face 12 is intended to be facing towards a user, while reverse face 14 is opposite to support face 12. The support face 12 is covered by cover 60, such that cover 60 is intended to be interposed between the user and support face 12.

Entanglement of fibers 10 comprises fibers. The fibers are made of thermoplastic material, forming loops and welded together. Thus, entanglement of fibers 10 has voids between the fibers allowing air to pass through entanglement of fibers 10. This results in a highly breathable padding 50, due to the numerous voids between the fibers which facilitate air circulation.

The fibers may be hollow fibers and/or solid fibers. The fibers may have a diameter of between 0.2 mm and 2 mm, preferably between 0.3 mm and 1.5 mm. The fibers are of a length much greater than the diameter of the fibers, and due to the method described below, for example, at least by a ratio of 100, or even 500, or even 1000. Very often, and in particular as is understood from the method of manufacturing, the fibers extend from a first end on a first edge of the 3D entanglement to a second end on a second edge of the entanglement, opposite the first edge.

The fibers may comprise a thermoplastic polymer, the composition of the fibers preferably comprising at least 95% by weight of polyester. For example, the composition of the fibers, or even of the padding, comprises:
95% to 99% by weight of a first polymer from the polyester family, such as PBT (Polybutylene terephthalate), and
1% to 5% by weight of a second polymer from the polyester family, such as PTT (Polytrimethylene terephthalate) or another polymer from the polyester family. The sum of PBT and PTT (or other) may be 100% by weight of the fibers, or even of the padding.

Entanglement of fibers 10 may have an apparent density that is between 20 kg/m³ and 70 kg/m³, or even between 45 kg/m³ and 65 kg/m³.

A first example of a method of manufacturing entanglement of fibers 10 will now be described. The method of manufacturing is a method of continuous manufacturing successively comprising the operations of a) extruding the fibers, b) welding the fibers, c) solidifying the fibers, then d) rolling the entanglement of fibers.

The extrusion operation a) comprises extruding a thermoplastic polymer from an extrusion die comprising extrusion nozzles, generally arranged in a succession of rows. Continuous fibers are thus generated. They form a sort of vertical curtain, the thermoplastic material in the molten state falling due to gravity. The temperature of the fibers exiting the extrusion die is preferably between 260° C. and 240° C. The extrusion die may be fed granules of thermoplastic polymer.

Operation b) of welding the fibers consists of or comprises passing the fibers between two guide members rotating in opposite directions in order to generate a layer of entangled fibers. The rotation speed of the guide members is lower than the speed of the fibers after extrusion. The gap between the guide members is small enough to press the fibers together and cause them to adhere by welding, and large enough to leave gaps between the fibers.

Solidification operation c) consists of or comprises cooling the layer of fibers that have been welded together, using a cooling liquid such as water, preferably by immersing the fibers in the cooling liquid. Operation c) follows operation b). The guide members may be partially immersed.

Operation d) of rolling the fibers consists of or comprises passing the layer of entangled fibers between two rollers preferably heated to a temperature that is between 140 and 160 degrees.

The layer of entangled fibers is produced continuously and is then guided out of the cooling liquid in order to be dried, generally by shaking/vibrating.

The layer of entangled fibers is cross-cut as its production advances, to form segments of entangled fibers. The precut segments of entangled fibers are then thermoformed. If the padding comprises a foam part in addition to the entanglement of fibers, the foam part is preferably produced after the fiber segment is thermoformed. A trimming operation is then carried out, to obtain padding 50. For further explanations concerning the production of the padding, reference may be made in particular to document EP 4 331 824 A1.

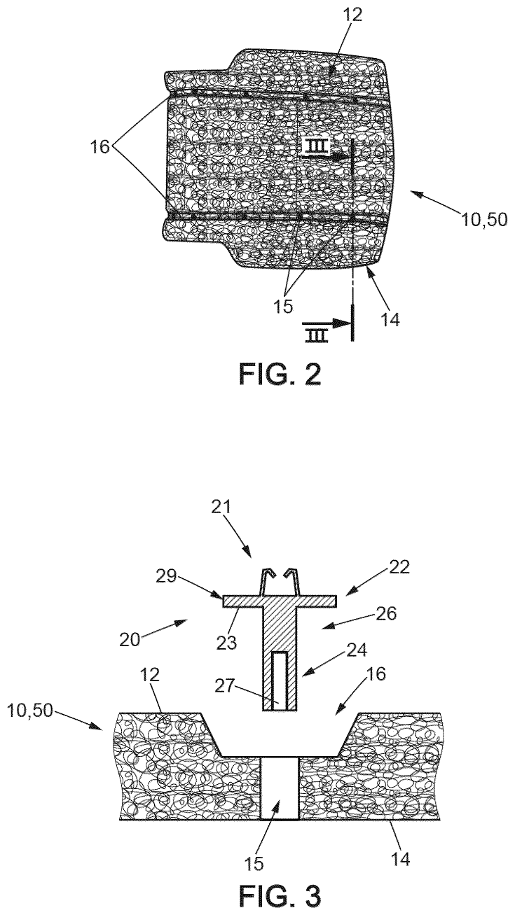

As illustrated in FIG. 2, padding 50 comprises entanglement of fibers 10. Entanglement of fibers 10 comprises thermoplastic fibers forming loops and welded to each other, which may be produced according to the method indicated above by way of example.

As illustrated in FIG. 2, entanglement of fibers 10 has grooves 16 and passages 15. In the embodiment illustrated in FIG. 2, grooves 16 are preferably created at the same time as passages 15 during the thermoforming operation. Passages 15 extend between support face 12 and reverse face 14, in other words passages 15 traverse entanglement of fibers 10. Grooves 16 are made by heating and compressing support face 12 at the location for grooves 16.

According to the exemplary embodiment of the padding assembly 100 illustrated in FIGS. 3 to 5, after the production of padding 50 illustrated in FIG. 10, a retaining element 20 is placed in each passage 15. More precisely, each retaining element 20 comprises a first portion 22, a second portion 24, and a connecting portion 26. First portion 22 comprises a support plate 29 and a hooking portion 21. Support plate 29 has a retaining surface 23. Hooking portion 21 is elastically deformable and projects from support plate 29 on the opposite side from retaining surface 23. Second portion 24 is hollowed out 27, such that second portion 24 is substantially tubular. Connecting portion 26 connects second portion 24 to first portion 22, more precisely to the support plate 29.

Retaining element 20 is made of solid material. Unlike entanglement of fibers 10, retaining element 20 is not compressible, and does not contain air. Furthermore, retaining element 20 is a single piece, first portion 22, second portion 24, and intermediate portion 26 being obtained as one piece. Retaining element 20 may be obtained in particular by molding, preferably injection molding, or by additive manufacturing.

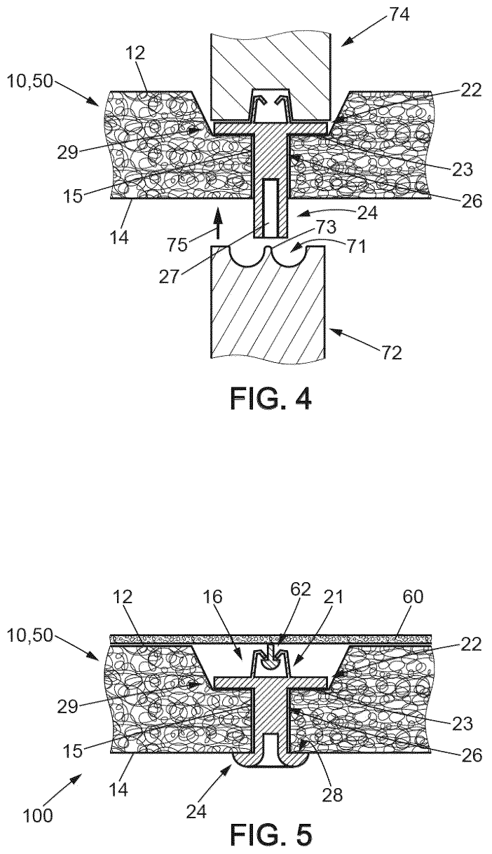

As illustrated in FIG. 4, second portion 24 and connecting portion 26 of the retaining element are successively inserted into passage 15 from support face 12, until retaining surface 23 of support plate 29 abuts against support face 12 of entanglement of fibers 10. Connecting portion 26 then extends into passage 15 and second portion 24 projects from reverse face 14 of entanglement of fibers 10.

A fusion device using ultrasonic vibrations is then used to attach retaining element 20 to entanglement of fibers 10. As illustrated in particular in FIG. 4, the fusion device comprises a sonotrode 72 and a support 74. Support 74 engages with first portion 22 in order to keep it stationary relative to entanglement of fibers 10. Sonotrode 72 comprises a head having a central pin 73 and a recess 71 of half-toroidal shape extending around central pin 73, in other words recess 71 has, in an axial cross-section (corresponding to the plane of FIG. 4), a recess in the shape of a half-circle on each side of central pin 73 and has a symmetry of revolution around central pin 73. Central pin 73 is inserted into hollow 27 of second portion 24, so that sonotrode 72 engages with second portion 24.

Then, the fusion device using ultrasonic vibrations is turned on, sonotrode 72 issues ultrasonic vibrations to heat second portion 24 which is stressed by the ultrasonic vibrations of sonotrode 72.

As the temperature rises and therefore second portion 24 softens, sonotrode 72 is moved closer towards support 74, in other words towards reverse face 14.

Second portion 24 is then crushed against reverse face 14 of entanglement of fibers 10. Second portion 24 is thus deformed by a technique corresponding to riveting. As illustrated in FIG. 5, second portion 24 forms an annular bead (of half-toroidal shape) and comprises the planar stop surface 28 which abuts against reverse face 14 of entanglement of fibers 10. Retaining element 20 is thus held in entanglement of fibers 10 by retaining surface 23 bearing against support face 12, stop surface 28 bearing against reverse face 14, and connecting portion 26 extending in passage 15.

After removing padding assembly 100 from the fusion device, as illustrated in particular in FIG. 5, support face 12 of entanglement of fibers 10 is then covered with cover 60. First portion 22 of retaining element 20 is entirely contained within groove 16, such that a user sitting on seat 1 will not feel the presence of retaining elements 10. Hooking studs 62 connected to cover 60 are inserted into first hooking portion 21, in order to engage with retaining elements 20 and retain cover 60 on entanglement of fibers 10.

Entanglement of fibers 10 is made of a first material, and the retaining element 20 is made of a second material. Optionally, the first material and the second material may be the same material, or different materials having similar physicochemical properties, in particular the same chemical composition. For example, the first material and the second material may each be a thermoplastic polymer, in particular a thermoplastic polymer in which the main-chain repeating unit comprises the ester functional group and optionally the ether functional group, more particularly a thermoplastic elastomer in which the main-chain repeating unit comprises the ester functional group and optionally the ether functional group. Thus, when sonotrode 72 melts second portion 24 of retaining element 20, second portion 24 superficially melts entanglement of fibers 10 in contact with second portion 24. The first material and the second material are then welded together, in particular second portion 24 at stop surface 28 is welded to the entanglement of fibers at reverse face 14. It may no longer be possible to precisely distinguish the boundary between entanglement of fibers 10 and retaining element 20 on padding assembly 100.

Entanglement of fibers 10 and retaining elements 20 can then no longer be separated. But padding assembly 100 can be recycled. To do this, cover 60 and hooking studs 62 are separated from retaining elements 20 and from entanglement of fibers 10. Then, entanglement of fibers 10 and retaining elements 20 are ground to produce granules. The granules thus obtained may then be reused to extrude the fibers of a new entanglement of fibers or new retaining elements.

Thus, entanglement of fibers 10 and retaining elements 20 may be recycled simultaneously, with no need to separate them.

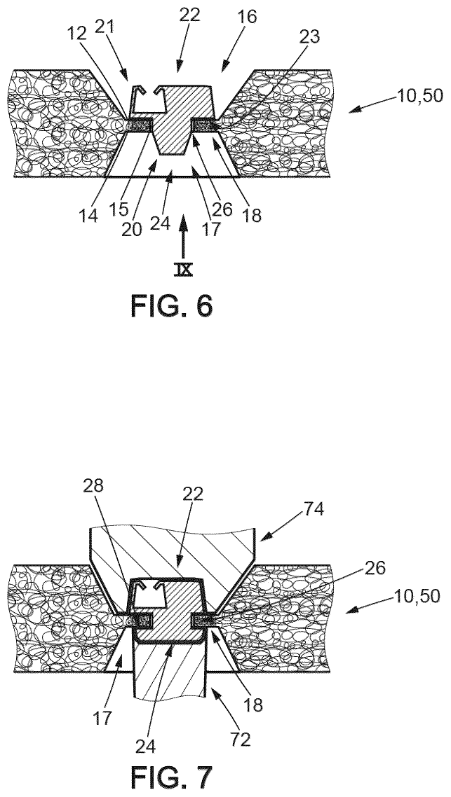

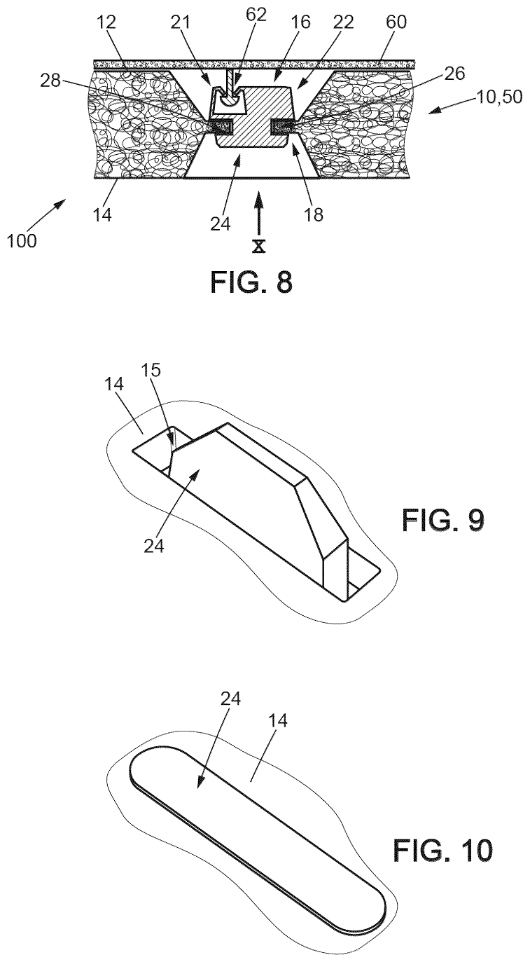

According to the second exemplary embodiment illustrated in FIGS. 6 to 10, padding assembly 100 differs from the padding assembly according to the first exemplary embodiment illustrated in FIGS. 3 to 5 in that entanglement of fibers 10 has a recess 17 created on reverse face 14 by compressing entanglement of fibers 10. This creates a compressed portion 18 substantially free of voids, in which passage 15 is created. Preferably, recess 17 is created at the same time as groove 16, during thermoforming.

Furthermore, and independently, as illustrated in particular in FIG. 9, padding assembly 100 according to the second exemplary embodiment differs from the padding assembly of the first exemplary embodiment in that passage 15 has an oblong cross-section and connecting portion 26 has a complementary cross-section.

Finally, padding assembly 100 according to the second exemplary embodiment differs from the padding assembly of the first exemplary embodiment in that second portion 24 is not hollowed out.

As illustrated in particular in FIG. 6, second portion 24 and connecting portion 26 of retaining element 20 are successively inserted into passage 15 from support face 12, until retaining surface 23 of retaining element 20 abuts against support face 12 of entanglement of fibers 10. Connecting portion 26 then extends in passage 15, and second portion 24 projects from reverse face 14 of entanglement of fibers 10.

As illustrated in particular in FIG. 7, support 74 of the fusion device engages with first portion 22, in order to hold it stationary relative to entanglement of fibers 10, while sonotrode 72 engages with second portion 24. When the fusion device is activated, sonotrode 72 heats second portion 24 by means of the ultrasonic vibrations that sonotrode 72 emits towards second portion 24. As the temperature rises and therefore second portion 24 softens, sonotrode 72 is moved closer towards support 74, in other words towards reverse face 14. Second portion 24 is thus deformed at the flat stop surface 28 which abuts against reverse face 14 of entanglement of fibers 10. In the second embodiment, second portion 24 has a substantially constant thickness and forms an oblong plate, as illustrated in particular in FIG. 10.

Preferably, second portion 24 superficially melts entanglement of fibers 10 at reverse face 14 via their contact, and if second portion 24 and entanglement of fibers 10 are made of materials having similar physicochemical properties, second portion 24 is welded to entanglement of fibers 10 at reverse face 14.

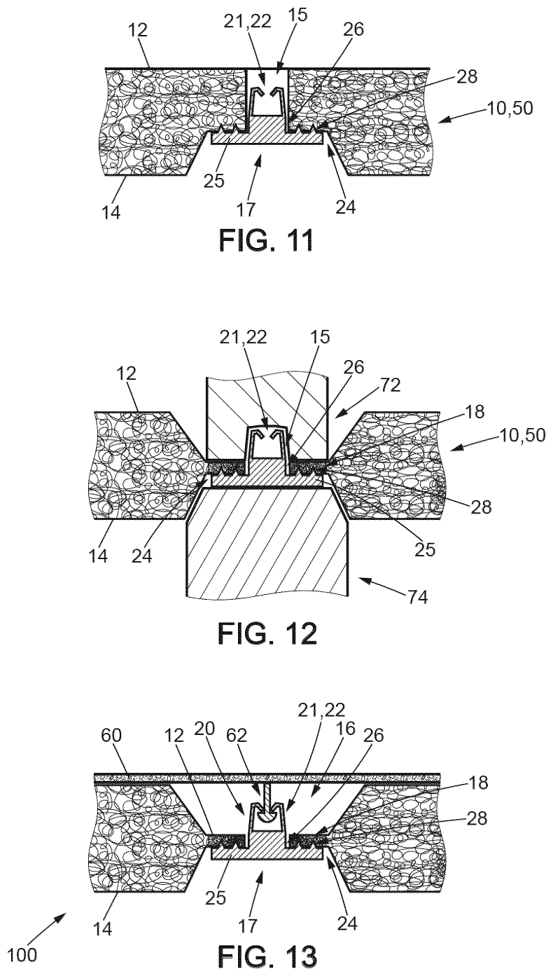

According to the third embodiment shown in FIGS. 11 to 13, entanglement of fibers 10, after thermoforming and before attaching the retaining elements, differs from the padding assembly of the second embodiment shown in FIGS. 6 to 10 in that entanglement of fibers 10 does not have a groove 16 on support face 12 (at least not near passage 15, in particular not around passage 15), but only a recess 17 created on reverse face 14 by compressing entanglement of fibers 10. In addition, first portion 22 of retaining elements 20 is without a retaining surface 23 coming into contact with support face 12, but the second portion comprises a stop plate 25 having a stop surface 28.

As illustrated in particular in FIG. 11, first portion 22 and connecting portion 26 of retaining element 20 are successively inserted into passage 15, until stop surface 28 of retaining element 20 abuts against reverse face 14 of entanglement of fibers 10. Connecting portion 26 and first portion 22 then extend in passage 15.

As illustrated in particular in FIG. 12, support 74 of the fusion device engages with second portion 24, in order to keep it stationary relative to entanglement of fibers 10, while sonotrode 72 comes to bear against support face 12 of entanglement of fibers 10, around passage 15. When the fusion device is activated, the ultrasonic vibrations of sonotrode 72 cause support face 12 of entanglement of fibers 10 to heat up around passage 15. As the temperature rises and entanglement of fibers 10 around passage 15 softens, sonotrode 72 is moved closer towards support 74, thus compressing entanglement of fibers 10 to form a compressed portion 18 in entanglement of fibers 10 around passage 15, as well as a groove 16, opposite recess 17. In other words, compressed portion 18 extends between groove 16 and recess 17. First portion 22 then projects from compressed portion 18 and extends into groove 16. In addition, the heating of entanglement of fibers 10 and the movement of sonotrode 72 towards support 74 causes stop plate 25 to heat up and stop surface 28 to melt. Entanglement of fibers 10 and the material of second portion 24 have similar physicochemical properties, such that stop surface 28 of second portion 24 welds to compressed portion 18.

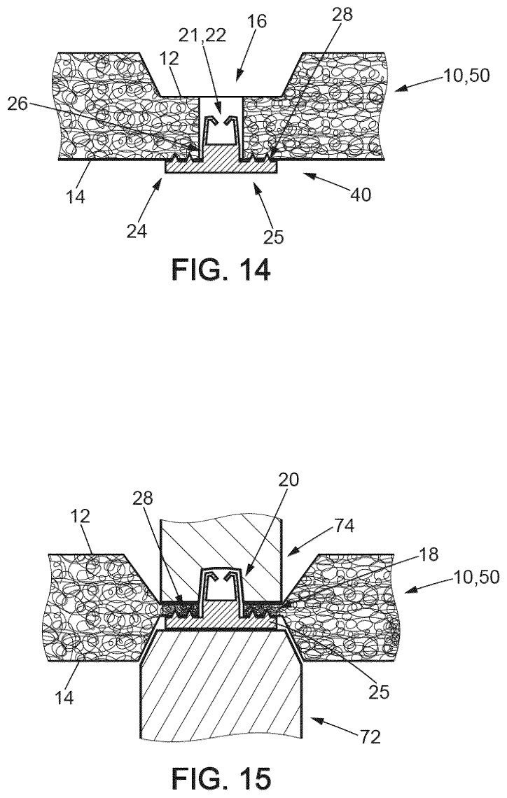

As illustrated in particular in FIG. 14, the variant of the third exemplary embodiment illustrated in FIGS. 14 and 15 differs from the third exemplary embodiment illustrated in FIGS. 11 to 13 in that entanglement of fibers 10 has a groove 16 on support face 12, but is without any recess 17 created on reverse face 14.

First portion 22 and connecting portion 26 of retaining element 20 are successively inserted into passage 15, until stop surface 28 of retaining element 20 abuts against reverse face 14 of entanglement of fibers 10. Connecting portion 26 and first portion 22 then extend in passage 15.

As illustrated in particular in FIG. 15, sonotrode 72 of the fusion device engages with second portion 24, while support 74 comes to bear against support face 12 of entanglement of fibers 10, around passage 15. When the fusion device is activated, the ultrasonic vibrations of sonotrode 72 heat up stop plate 25, stop surface 28, and reverse face 14 around passage 15 in contact with stop surface 28. As the temperature rises and therefore entanglement of fibers 10 around passage 15 softens, sonotrode 72 is moved closer towards support 74, thus compressing entanglement of fibers 10 to form a compressed portion 18 in entanglement of fibers 10 around passage 15, as well as a recess 17, opposite groove 16. In other words, the material of entanglement of fibers 10 and the material of second portion 24 have similar physicochemical properties, such that stop surface 28 of second portion 24 welds to compressed portion 18.

Comparative seat padding was made largely from urethane polymer foam (polyurethane, abbreviated as PU), particularly polyurethane foam obtained by a chemical reaction between a polyol and a diisocyanate. More specifically, a polyether/polyol type of polyol was used, which resulted in crosslinked polyurethane (CLPU) padding. Such foam allows for relatively easy shaping in a mold and also allows for the easy integration of elements, such as retaining elements, into the padding, by arranging them in the mold.

Comparative polyurethane foam padding is certainly satisfactory, but it also has disadvantages, such as its tendency to retain moisture and its adverse effects on the environment. The tendency to retain moisture can cause user discomfort. Furthermore, the chemical reaction to produce polyurethane foam emits carbon dioxide, thus contributing to global warming. In addition, polyurethane cannot be recycled by reusing it to form new padding.

A comparative padding assembly for a vehicle seat, comprising a padding, the padding comprising an entanglement of fibers, the entanglement of fibers comprising fibers, the fibers being made of thermoplastic material, forming loops and welded to each other, the entanglement of fibers having a support face and a reverse face, the support face being intended to face towards a user, the reverse face being opposite to the support face, the entanglement of fibers having a passage extending between the support face and the reverse face. The padding assembly further comprises a fastening device produced by increasing the density of the entanglement of fibers.

The present disclosure aims to propose an alternative solution that is robust, easy to implement, and inexpensive.

According to the disclosure, the padding assembly further comprises a retaining element, the retaining element comprising a first portion, a second portion, and a connecting portion, the first portion comprising a hooking portion intended to retain a cover which covers the support face, the second portion engaging with the reverse face to hold the retaining element in the entanglement of fibers, the connecting portion extending in the passage and connecting the first portion to the second portion, and the retaining element being fixed to the entanglement of fibers by a melting of material.

The padding can thus provide the flexibility necessary for user comfort and the retaining element can have high robustness.

In another feature in accordance with the disclosure, the retaining element is preferably fixed to the entanglement of fibers by fusion using ultrasonic vibrations.

Fusion using ultrasonic vibrations allows melting the elements only locally at the point where they are in contact, in order to secure them while avoiding deformation, particularly at the hooking portion.

In another feature in accordance with the disclosure, the retaining element is preferably a single piece.

The retaining element is thus simpler and more robust.

In another feature in accordance with the disclosure, the retaining element is made of solid material.

The robustness of the retaining element is thus increased. The retaining element does not need to offer as much flexibility as the padding, since it is not intended to come into contact with the user.

In another feature in accordance with the disclosure, the retaining element is preferably obtained by additive manufacturing.

The retaining element may thus have complex shapes.

In another feature in accordance with the disclosure, the second portion preferably has a stop surface which abuts against the reverse side of the entanglement of fibers, and the stop surface is fixed to the entanglement of fibers by melting the entanglement of fibers.

The positioning and retention of the retaining element relative to the entanglement of fibers are thus improved.

In an additional feature in accordance with the disclosure, the passage preferably has an oblong cross-section and the connecting portion of the retaining element has a complementary cross-section.

The connecting portion is thus prevented from rotating in the passage.

In an alternative feature according to the present disclosure, the first portion preferably has a retaining surface which abuts against the support face of the entanglement of fibers, and the second portion is crushed by melting and has a stop surface which abuts against the reverse face of the entanglement of fibers.

The positioning and retention of the retaining element relative to the entanglement of fibers are thus also improved.

In a complementary feature according to the present disclosure, the retaining element is preferably deformed by riveting.

In a complementary or alternative feature according to the disclosure, the second portion preferably has an annular (half-toroidal) bead shape.

This thus creates a reinforcement at the connection between the retaining element and the entanglement of fibers.

In an additional feature in accordance with the disclosure, the entanglement of fibers is preferably of increased density around the passage.

The strength of the entanglement of fibers is thus increased near its attachment to the retaining element.

In another additional feature in accordance with the disclosure, the entanglement of fibers is preferably made of a first material and the retaining element is made of a second material, the first material and the second material having similar physicochemical properties.

Thus, not only is the retaining element held in place relative to the entanglement of fibers by obstacles, but, in addition, the retaining element is welded to the entanglement of fibers.

In various embodiments of the padding assembly according to the disclosure, one more of the following arrangements may optionally be used:
the first material and the second material are each a thermoplastic polymer having a main-chain repeating unit comprising an ester or ether functional group;
the first material and the second material have the same chemical composition;
the first material and the second material comprise at least 90% poly(ethylene terephthalate),
the hooking portion is elastically deformable.

In another feature in accordance with the disclosure, the padding assembly further comprises a cover and a hooking stud connected to the cover, the cover covers the support face of the entanglement of fibers, and the hooking stud engages with the hooking portion to retain the cover on the entanglement of fibers.

The present disclosure further relates to a method of producing a padding assembly for a vehicle seat. The method comprises the following operations:
a) providing a padding comprising an entanglement of fibers and a retaining element, the entanglement of fibers comprising fibers made of thermoplastic material, forming loops and welded to each other, the entanglement of fibers having a support face and a reverse face, the support face being intended to face towards a user, the reverse face being opposite to the support face, the entanglement of fibers having a passage extending between the support face and the reverse face, the retaining element comprising a first portion, a second portion, and a connecting portion, the first portion comprising a hooking portion intended to retain a cover which covers the support face, the connecting portion connecting the first portion to the second portion,
b) inserting the connecting portion into the passage,
c) engaging the second portion with the reverse face and fixing the retaining element to the entanglement of fibers by a melting of material.

In various embodiments of the method according to the disclosure, one or more of the following arrangements may optionally be used:
during operation c), a sonotrode generating ultrasonic vibrations is used;
during operation b), the first portion is inserted into the passage, then the connecting portion is inserted into the passage until a stop surface of the second portion abuts against the reverse face of the entanglement of fibers;
during operation c), the second portion is held on a support, the sonotrode is applied against the support face of the entanglement of fibers, and the sonotrode is brought closer to the support;
during operation c), the support face of the entanglement of fibers is applied against a support, the second portion is held on the sonotrode, and the sonotrode is brought closer to the support;
during operation b), the second portion is inserted into the passage, then the connecting portion is inserted into the passage until a retaining surface of the first portion abuts against the support face of the entanglement of fibers;
during operation c), the first portion is applied against a support, the second portion is held on the sonotrode, the sonotrode melts the second portion by means of ultrasonic energy, then the sonotrode is brought closer to the support in order to crush the second portion against the reverse face of the entanglement of fibers;
the sonotrode has a head with a recess in the shape of a half-toroid;
operation a) comprises producing the retaining element by additive manufacturing.

A padding assembly (100) for a vehicle seat (1), comprising: a padding (50) comprising an entanglement of fibers (10), the entanglement of fibers (10) comprising fibers, the fibers being made of thermoplastic material, forming loops and welded to each other, the entanglement of fibers (10) having a passage (15), a retaining element (20), the retaining element (20) comprising a first portion (22), a second portion (24), and a connecting portion (26), the first portion (22) comprising a hooking portion (21), the second portion (24) engaging with the reverse face (14), the connecting portion (26) extending in the passage (15), the retaining element (20) being fixed to the entanglement of fibers (10) by a melting of material.

1. A padding assembly for a vehicle seat, the padding assembly comprising:
a padding comprising an entanglement of fibers, the entanglement of fibers comprising fibers, the fibers being made of thermoplastic material, forming loops and welded to each other, the entanglement of fibers having a support face and a reverse face, the support face being intended to face towards a user, the reverse face being opposite to the support face, the entanglement of fibers having a passage extending between the support face and the reverse face,
a retaining element, the retaining element comprising a first portion, a second portion, and a connecting portion, the first portion comprising a hooking portion intended to retain a cover which covers the support face, the second portion engaging with the reverse face to hold the retaining element in the entanglement of fibers, the connecting portion extending in the passage and connecting the first portion to the second portion, the retaining element being fixed to the entanglement of fibers by a melting of material.

2. The padding assembly of claim 1, wherein the retaining element is fixed to the entanglement of fibers by fusion using ultrasonic vibrations.

3. The padding assembly of claim 1, wherein the entanglement of fibers is made of a first material and the retaining element is made of a second material, the first material and the second material having similar physicochemical properties.

4. The padding assembly of claim 1, wherein the padding assembly further comprises a cover and a hooking stud connected to the cover, the cover covers the support face of the entanglement of fibers, and the hooking stud engages with the hooking portion to retain the cover on the entanglement of fibers.

5. A method of producing a padding assembly for a vehicle seat, comprising the following operations:
a) providing a padding comprising an entanglement of fibers and a retaining element, the entanglement of fibers comprising fibers made of thermoplastic material, forming loops and welded to each other, the entanglement of fibers having a support face and a reverse face, the support face being intended to face towards a user, the reverse face being opposite to the support face, the entanglement of fibers having a passage extending between the support face and the reverse face, the retaining element comprising a first portion, a second portion, and a connecting portion, the first portion comprising a hooking portion intended to retain a cover which covers the support face, the connecting portion connecting the first portion to the second portion,
b) inserting the connecting portion into the passage,
c) engaging the second portion with the reverse face and fixing the retaining element to the entanglement of fibers by a melting of material.

6. The method of claim 5, wherein, during operation b), the first portion is inserted into the passage, then the connecting portion is inserted into the passage until a stop surface of the second portion abuts against the reverse face of the entanglement of fibers.

7. The method of claim 5, wherein, during operation c), a sonotrode generating ultrasonic vibrations is used and the second portion is held on a support, the sonotrode is applied against the support face of the entanglement of fibers, and the sonotrode is brought closer to the support.

8. The method claim 6, wherein, during operation c), a sonotrode generating ultrasonic vibrations is used and the support face of the entanglement of fibers is applied against a support, the second portion is held on the sonotrode, and the sonotrode is brought closer to the support.

9. The method of claim 5, wherein, during operation b), the second portion is inserted into the passage, then the connecting portion is inserted into the passage until a retaining surface of the first portion abuts against the support face of the entanglement of fibers, and, during operation c), a sonotrode generating ultrasonic vibrations is used.

10. The method of claim 5, wherein, during operation c), the first portion is applied against a support, the second portion is held on the sonotrode, the sonotrode melts the second portion by means of ultrasonic energy, then the sonotrode is brought closer to the support in order to crush the second portion against the reverse face of the entanglement of fibers.
